(19) United States
(12) Patent Application Publication
(10) Pub. No.: US 2006/0173913 A1
(43) Pub. Date: Aug. 3, 2006

(54) Image Processing Apparatus and Image Processing Method

(75) Inventor: Satoshi Aoyama, Kawasaki-shi (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 11/275,660

(22) Filed: Jan. 23, 2006

(30) Foreign Application Priority Data
Jan. 31, 2005 (JP) 2005-023941
Sep. 27, 2005 (JP) 2005-280371

(51) Int. Cl. G06F 17/00; G06F 7/00

(52) U.S. Cl. 707/104.1

(57) ABSTRACT

The file name of an image file as a saving target is acquired (S401). A hash value is calculated on the basis of the acquired file name (S402). The image file as the saving target is saved in association with the data of the hash value.

### FIELD OF THE INVENTION

The present invention relates to a technique of storing an image as a possible search target in a recording medium.

### BACKGROUND OF THE INVENTION

A high-speed operation is required of a digital camera from various viewpoints of, e.g., allowing a user to sense an image by user's intended operation at a user's desirable timing and providing a response to make the user comfortably operate without any stress. Along with a recent increase in capacity of a recording medium used in a digital camera, it is becoming difficult to access desired image data at a high speed.

Conventionally, a general solution to this problem is to cache, in an internal memory, information read out from the recording medium. When necessary information is cached in the internal memory, the number of times of read/write access to a low-speed recording medium decreases, and high-speed file search is realized by high-speed processing between internal memories.

However, an internal memory provided in an information device such as a digital camera has a much smaller capacity than an external recording medium. The increase in capacity of a recording medium is accelerating more and more so that there is a limit in causing a small-capacity internal memory to handle several thousands of image files saved in a recording medium with a capacity of several GB.

If the capacity of the internal memory is simply increased to cope with the problem as before, the product cost rises, and no inexpensive product can be provided. Even if a large internal memory can be incorporated, file read into the cache is time-consuming, and the load for update processing to delete/add data from/to the cache becomes heavy. Hence, quick response can hardly be realized. There is required a capability to quickly search for a file without using a cache.

As a solution without using a cache, Japanese Patent Laid-Open No. 2000-10843 proposes a file system which adds hash table management information to implement a table of hash values based on file names to a block that stores the directory entry of files managed by the file system in the storage device.

According to this technique, hash values are obtained from file names in advance. Information to implement a list structure for each directory entry having a coinciding hash value is stored in the block of the directory entry. In file search, character string comparison to each file need not be executed. Instead, a hash value is obtained from the file name of the search target, and character string comparison is executed for only the list of directory entry with the coinciding hash value, thereby shortening the search time.

In the technique described in Japanese Patent Laid-Open No. 2000-10843, however, every time a normal file operation of adding, deleting, renaming, or moving a file in the storage device is performed, cumbersome maintenance processing must be executed to continuously use the hash table. This produces an additional load on the file system.

In addition, since a directory entry is implemented as a hash table, a large quantity of hash table management information is necessary. If an unexpected system failure such as accidental power down occurs in an information device with such a file system, the hash table management information may be lost. Even when only part of the information is lost, the entire file system may be damaged. That is, this file system is a very vulnerable system without much safety.

As another problem, in a file system which allows not only a short file name (8 bytes before the extension and 3 bytes after the extension: a total of 11 bytes at maximum) but also a long file name in more bytes, file search is required to be as efficient as that using a short file name.

For example, in VFAT (Virtual File Allocation Table) extended to cope with a long file name while maintaining compatibility to general FAT (File Allocation Table), the character string comparison time simply increases because the file name is long. Furthermore, there is also a problem caused by the difference in the directory entry data structure between the short file name and the long file name.

FIG. 1A is a view showing a structure example of the directory entry of a short file name “ABCDEFGH.TXT” in VFAT. FIG. 1B is a view showing a structure example of the directory entry of a long file name “ABCD . . . XYZ123.TXT” in VFAT.

A long file name can have a maximum of 255 characters. The directory entry itself may have 600 bytes or more. In this case, only analyzing the directory entry and extracting the file name increases the load as compared to the short file name.

In addition, since the directory entry itself is bulky, it may be arranged across physical sectors. When an external recording medium is used as the storage device, and the directory entry is arranged across sectors, extra read processing for the slow external device is necessary to read another sector, resulting in long time.

In file systems to handle a long file name, including VFAT, the performance of file search for a number of files by the conventional file name character string comparison is poor.

### SUMMARY OF THE INVENTION

The present invention has been made in consideration of the above-described problems, and has as its object to provide a technique of quickly and efficiently searching an enormous number of files including long file names for a desired file without increasing the load on the file system.

In order to achieve an object of the present invention, for example, an image processing apparatus of the present invention comprises the following arrangement.

That is, an image processing apparatus for storing an image in a recording medium, comprising:

acquisition means for acquiring identification information to identity an image file in storing the image file in the recording medium;

calculation means for calculating a hash value on the basis of the identification information; and

storage control means for controlling to store the image file in the recording medium in association with the hash value.

In order to achieve an object of the present invention, for example, an image processing method of the present invention comprises the following arrangement.

That is, an image processing method of storing an image in a recording medium, comprising:

an acquisition step of acquiring identification information to identity an image file in storing the image file in the recording medium;

a calculation step of calculating a hash value on the basis of the identification information; and

a storage control step of controlling to store the image file in the recording medium in association with the hash value.

In order to achieve an object of the present invention, for example, an image processing method of the present invention comprises the following arrangement.

That is, an image processing method of storing an image in a recording medium, comprising:

an identification information acquisition step of acquiring identification information to identity an image file in storing the image file in the recording medium;

a file information acquisition step of acquiring file information of the image file;

a calculation step of calculating a hash value on the basis of the identification information and the file information; and

a storage control step of controlling to store the image file in the recording medium in association with the hash value.

In order to achieve an object of the present invention, for example, an image processing apparatus of the present invention comprises the following arrangement.

That is, an image processing apparatus for storing an image in a recording medium, comprising:

identification information acquisition means for acquiring identification information to identity an image file in storing the image file in the recording medium;

file information acquisition means for acquiring file information of the image file;

calculation means for calculating a hash value on the basis of the identification information and the file information; and

storage control means for controlling to store the image file in the recording medium in association with the hash value.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1A is a view showing a structure example of the directory entry of a short file name “ABCDEFGH.TXT” in VFAT;

FIG. 1B is a view showing a structure example of the directory entry of a long file name “ABCD . . . XYZ123.TXT” in VFAT;

FIG. 2 is a block diagram showing the hardware configuration of an image sensing apparatus to which an image processing apparatus according to the first embodiment of the present invention is applied;

FIG. 3 is a view showing the data structure of a directory entry in a file system according to the embodiment which is installed in a digital camera 100;

FIG. 4 is a flowchart showing details of image file creation and image file save processing in step S805;

FIG. 5 is a flowchart of image file name change processing in step S810;

FIG. 6 is a flowchart of image file search processing in step S806;

FIG. 7 is a view showing a structure example of a file storage area including FAT;

FIG. 8 is a flowchart of the basic operation of the digital camera 100;

FIG. 9 is a view showing the structure of a hash value containing file attribute information according to the third embodiment of the present invention; and

FIG. 10 is a flowchart of image file search processing according to the third embodiment of the present invention.

### DETAILED DESCRIPTION OF THE PREFERRED EMBODIMENTS

Preferred embodiments of the present invention will now be described in detail in accordance with the accompanying drawings.

### First Embodiment

<Hardware Configuration of Image Sensing Apparatus>

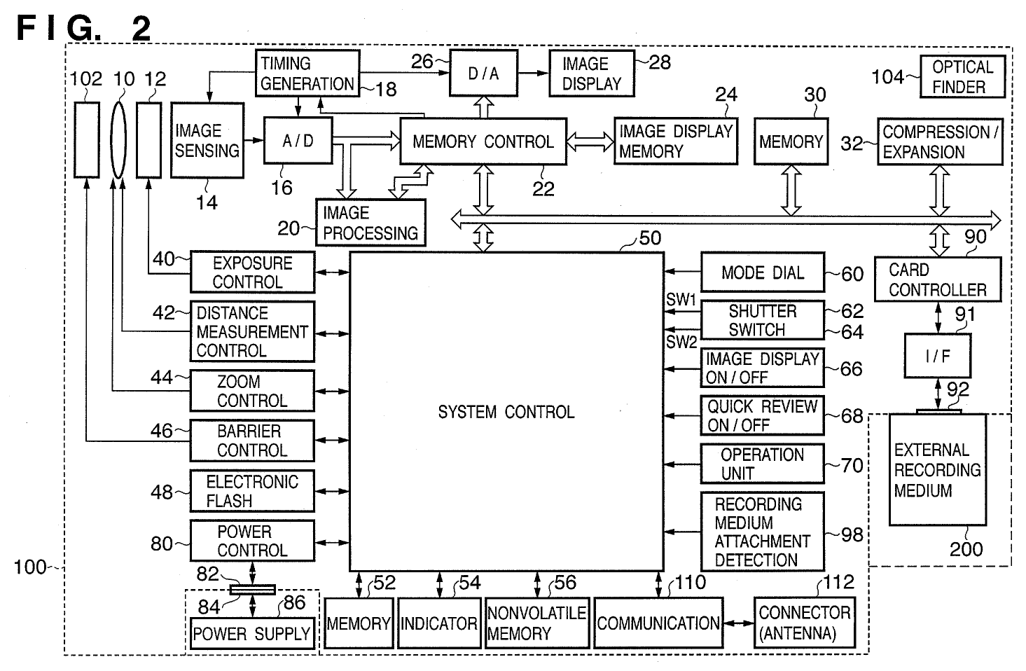

FIG. 2 is a block diagram showing the hardware configuration of an image sensing apparatus to which an image processing apparatus according to this embodiment is applied. This image sensing apparatus is a digital camera capable of sensing a still image or moving image in a physical space.

Referring to FIG. 2, reference numeral 100 denotes an image sensing apparatus body.

Reference numeral 10 denotes a photographing lens; and 12, a shutter. An image sensing element 14 converts an optical image into an electrical signal. An A/D converter 16 converts an analog signal output from the image sensing element 14 into a digital signal. A timing generation circuit 18 supplies a clock signal or control signal to the image sensing element 14, A/D converter 16, and D/A converter 26. The timing generation circuit 18 is controlled by a memory control circuit 22 and system control circuit 50.

An image processing circuit 20 executes predetermined pixel interpolation processing or color conversion processing for data from the A/D converter 16 or data from the memory control circuit 22. The image processing circuit 20 also executes predetermined arithmetic processing by using sensed image data. On the basis of the obtained arithmetic result, the system control circuit 50 controls an exposure control circuit 40 and distance measurement control circuit 42. That is, AF (Auto Focus) processing, AE (Auto Exposure) processing, and EF (Electronic Flash pre-emission) processing of the TTL (Through The Lens) scheme are executed. The image processing circuit 20 also executes predetermined arithmetic processing by using sensed image data and executes AWB (Auto White Balance) processing of the TTL scheme on the basis of the obtained arithmetic result.

The memory control circuit 22 controls the A/D converter 16, timing generation circuit 18, image processing circuit 20, image display memory 24, D/A converter 26, memory 30, and compression/expansion circuit 32.

Data from the A/D converter 16 is written in the image display memory 24 or memory 30 from the memory control circuit 22 directly or through the image processing circuit 20.

Reference numeral 24 denotes an image display memory; 26, a D/A converter; and 28, an image display unit formed from, e.g., a TFT LCD. Display image data written in the image display memory 24 is converted into an analog signal by the D/A converter 26 and output to the image display unit 28 so that an image corresponding to the image data is displayed on the image display unit 28. When obtained image data are sequentially displayed by using the image display unit 28, an electronic finder function can be implemented. The image display unit 28 can arbitrarily turn on/off its display by an instruction from the system control circuit 50. In a display OFF state, power consumption of the digital camera 100 can largely be reduced.

The memory 30 stores data of a sensed still image or moving image and has a sufficient capacity to store a predetermined number of still images or a moving image for a predetermined time. Even in a panoramic mode or a continuous shooting mode to continuously take a plurality of still images, a large quantity of images can quickly be written in the memory 30. The memory 30 can also be used as a work area of the system control circuit 50.

The compression/expansion circuit 32 compresses/expands image data by, e.g., ADCT (Adaptive Discrete Cosine Transform). The compression/expansion circuit 32 reads out an image from the memory 30, compresses or expands the image data, and writes the processed data in the memory 30.

The exposure control circuit 40 controls the shutter 12 having an iris diaphragm function. The exposure control circuit 40 also has a flash brightness control function in cooperation with an electronic flash 48.

The distance measurement control circuit 42 controls focusing of the photographing lens 10. A zoom control circuit 44 controls zooming of the photographing lens 10. A barrier control circuit 46 controls the operation of a protection unit 102 serving as a barrier. The electronic flash 48 has an AF auxiliary light projecting function and a flash light control function. The exposure control circuit 40 and distance measurement control circuit 42 are controlled by the TTL scheme. That is, on the basis of an arithmetic result obtained by causing the image processing circuit 20 to calculate the obtained image data, the system control circuit 50 controls the exposure control circuit 40 and distance measurement control circuit 42.

The system control circuit 50 controls the sections of the digital camera 100. A memory 52 stores programs and data necessary for causing the system control circuit 50 to execute control of sections of the digital camera 100 and processing (to be described later) to be executed by the digital camera 100.

An indicator unit 54 such as a liquid crystal display device or a speaker indicates the operation state or a message by using a text, image, or sound in accordance with program execution by the system control circuit 50. One or a plurality of indicator units 54 are arranged at visible positions near the operation unit of the digital camera 100 by combining, e.g., an LCD, LED, and sound generation element. Some of the functions of the indicator unit 54 are arranged in an optical finder 104.

Of the indication contents of the indicator unit 54, examples of indication on the LED are the single shot/continuous shooting mode, self timer, compression ratio, number of recording pixels, number of recorded images, number of recordable images, shutter speed, F-number, exposure compensation, flash, red-eye effect relaxation, macro shooting, buzzer setting, timer battery level, battery level, error, information by a plurality of digits, attached state of an external recording medium 200, communication I/F operation, and date/time.

Of the indication contents of the indicator unit 54, examples of indication in the optical finder 104 are in-focus, camera shake warning, flash charge, shutter speed, F-number, and exposure compensation.

An electrically erasable/recordable nonvolatile memory 56 is, e.g. an EEPROM. Reference numerals 60, 62, 64, 66, 68, and 70 denote operation units to input various kinds of operation instructions of the system control circuit 50. They include single devices such as a switch, dial, touch panel, pointing by detection of a line of sight, and voice recognition device, or a combination of a plurality of devices. These operation units will be described here in detail.

The mode dial switch 60 can selectively set function modes such as power off, auto shooting, shooting, panoramic shooting, playback, multiwindow playback/erase, and PC connection.

The shutter switch SW1 62 is turned on midway during the operation of a shutter button (not shown) and instructs the start of an operation such as AF (Auto Focus) processing, AE (Auto Exposure) processing, AWB (Auto White Balance) processing, or EF (Electronic Flash pre-emission) processing.

The shutter switch SW2 64 is turned on at the end of operation of a shutter button (not shown) and instructs the start of a series of processing operations including exposure processing of writing, as data, a signal read from the image sensing element 14 in the memory 30 through the A/D converter 16 and memory control circuit 22, development processing using calculation by the image processing circuit 20 or memory control circuit 22, and recording processing of reading out image data from the memory 30, causing the compression/expansion circuit 32 to compress the image data, and writing it in the recording medium 200.

The image display ON/OFF switch 66 can set ON/OFF of the image display unit 28. With this function, current supply to the image display unit 28 including a TFT LCD can be stopped in shooting using the optical finder 104 so that power can be saved.

The quick review ON/OFF switch 68 sets a quick review function of automatically playing back sensed image data immediately after shooting. In this embodiment, especially, the quick review function is set when the image display unit 28 is OFF.

The operation unit 70 includes various kinds of buttons and a touch panel. The operation unit 70 has a menu button, set button, macro button, multiwindow playback page break button, flash setting button, single shot/continuous shot/self timer switching button, menu move + (plus) button, menu move − (minus) button, playback image move + (plus) button, playback image move − (minus) button, sensed image quality selection button, exposure compensation button, and date/time setting button.

A power control circuit 80 includes a battery detection circuit, DC/DC converter, and switch circuit which selects a block to be energized. The power control circuit 80 detects the presence/absence of a battery, battery type, and battery level, controls the DC/DC converter on the basis of the detection result and an instruction from the system control circuit 50, and supplies a necessary voltage to the units including a recording medium for a necessary period.

Reference numerals 82 and 84 denote connectors; and 86, a power supply unit such as a primary cell such as an alkaline cell or lithium cell, a secondary cell such as an NiCd cell, NiMH cell, or Li cell, or an AC adapter.

Reference numeral 90 denotes a card controller which transmits/receives data to/from an external recording medium such as a memory card; 91, an interface (I/F) to an external recording medium such as a memory card; 92, a connector to be connected to an external recording medium such as a memory card; and 98, a recording medium attachment detection unit which detects whether the external recording medium 200 is attached to the connector 92.

In this embodiment, the interface or connector to attach a recording medium can have either one or a plurality of systems. In addition, interfaces or connectors of different standards may be combined. Interfaces and connectors based on a standard such as a PCMCIA card or CF (compact flash®) card may be used.

When the interface 91 and connector 92 based on a standard such as a PCMCIA card or CF (compact flash®) card are used, and various kinds of communication cards such as a LAN card, modem card, USB card, IEEE1394 card, P1284 card, SCSI card, and communication card for PHS are connected, image data or management information associated with the image data can be transferred to/from another computer or a peripheral device such as a printer.

The protection unit 102 serves as a barrier which covers the image sensing unit including the lens 10 of the digital camera 100 to prevent any dirt or damage to the image sensing unit.

Shooting can be executed by using only the optical finder 104 without using the electronic finder function by the image display unit 28. The optical finder 104 incorporates some functions of the indicator unit 54, including, e.g., in-focus indication, camera shake warning indication, electronic flash charge indication, shutter speed indication, F-number indication, and exposure compensation indication.

The external recording medium 200 is, e.g., a memory card.

<FAT>

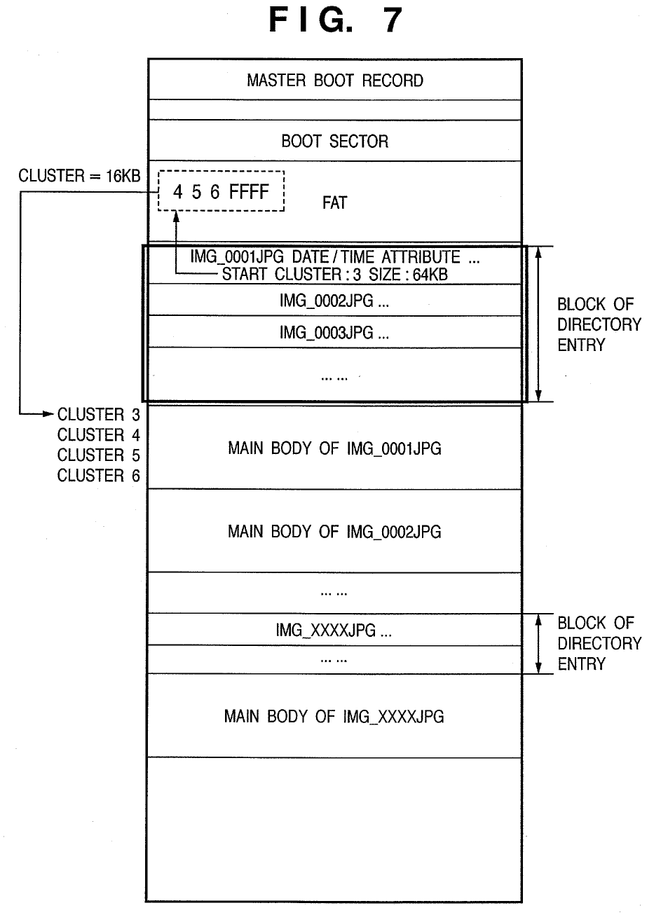

FAT is known as a general file system. FIG. 7 shows its outline.

FIG. 7 is a view showing a structure example of a file storage area including FAT. As shown in FIG. 7, a management area including a master boot record (MBR), boot sector, and FAT is set in the start area of FAT. Pieces of fundamental information about the file system are written here, including a data area size and cluster size representing the minimum unit of logical storage on the storage device. A data area is placed next. In this embodiment, sensed image files are stored here.

A file is normally stored in the data area. The most fundamental method of acquiring an image file with a name, e.g., “IMG_{—}0001.JPG” by using FAT will be described.

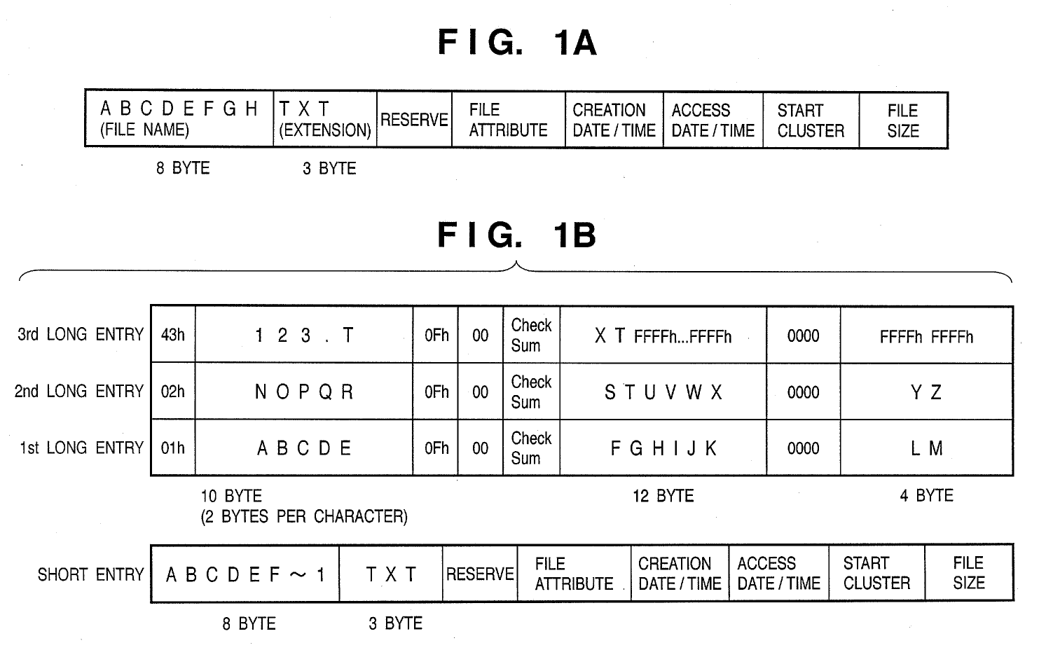

The file system first finds a directory entry block including directory entries described above. A directory entry has the above-described structure shown in FIG. 1A or 1B. To find a target file from the directory entries, the character string of the file name of each directory entry is compared with that of the search target. When an appropriate directory entry is found, the start cluster in the found directory entry is acquired. The table in the FAT area is referred to from the acquired start cluster, thereby grasping the cluster chain that represents which cluster is used by the file.

In the example in FIG. 7, the image file with the file name “IMG_{—}0001.JPG” has start cluster 3 and uses four clusters 3, 4, 5, and 6 (the size per cluster is 16 KB; 16 KB×4=64 KB) as indicated in the FAT area. In this way, the system recognizes that the image file with the file name “IMG_{—}0001.JPG” is present in clusters 3 to 6. When this part is read out, the search target file can be acquired.

<Directory Entry>

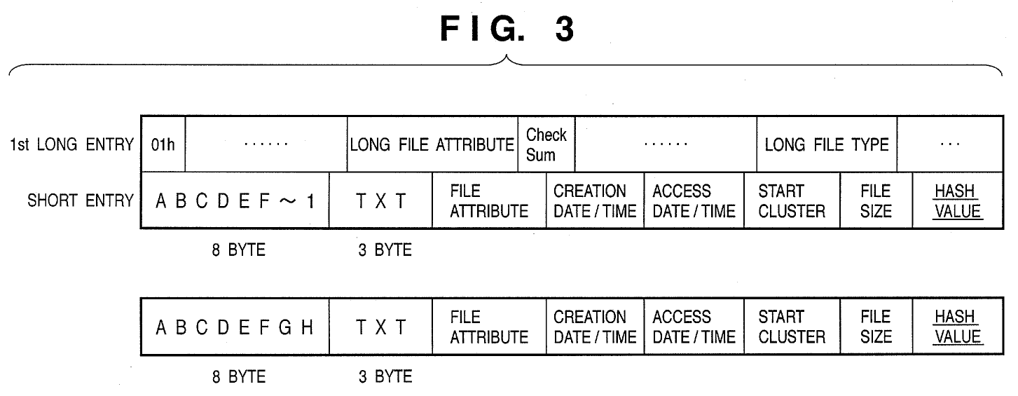

The directory entry will be explained next. FIG. 3 is a view showing the data structure of a directory entry in the file system according to this embodiment which is installed in the digital camera 100.

The directory entry according to this embodiment contains items such as a creation date/time, access date/time, file attribute, start cluster, and file size (simply “size” in FIG. 3), like the directory entry in VFAT shown in FIG. 1A or 1B. In addition, a hash value calculated for each file on the basis of its file name (or the full path name of the file) is contained, as shown in FIG. 3.

In this embodiment, the entry of an image file having a long file name has almost the same structure as in VFAT. Compatibility to VFAT need not always be ensured.

The function used to calculate the hash value is set in the following way. For example, assume that the hash value is calculated from the file name. The characters included in the character string (“IMG_{—}0001.JPG” in the example in FIG. 7) of the file name are added as binary data. Redundancy is expected to increase in simple addition. To prevent this, arithmetic processing such as bit shift is inserted into addition such that a unique value is obtained for each file name as much as possible. One hash value is set for one directory entry. In an entry with a long file name, a hash value is set only for the short entry.

<Basic Operation of Digital Camera 100>

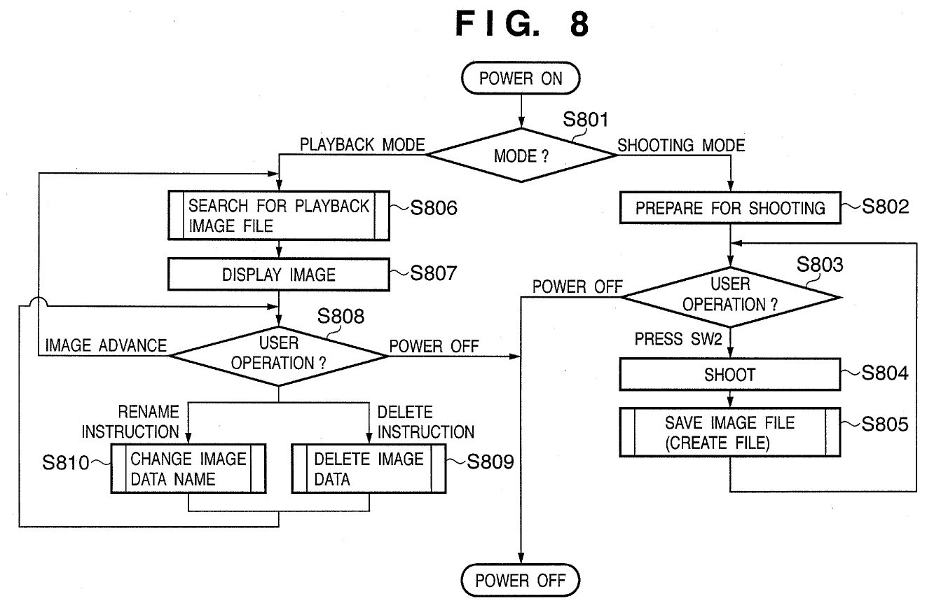

FIG. 8 is a flowchart of the basic operation of the digital camera 100. Programs and data to cause the system control circuit 50 to execute processing according to the flowchart in FIG. 8 are stored in the memory 52. When the system control circuit 50 performs processing using the programs and data, the digital camera 100 executes each processing to be described below.

When the operator of the present invention presses the power button provided on the operation unit 70, the system control circuit 50 detects it and activates the units of the digital camera 100. Then, the system control circuit 50 checks the current mode set by the mode change-over switch provided on the operation unit 70 (step S801).

If a shooting mode is set, the processing advances to step S802 to prepare (initialize) the units that should operate for shooting (step S802). When the units are ready for shooting, the system control circuit waits for an operation input from the operator. When an instruction to power off the camera is input by, e.g., re-pressing the power button provided on the operation unit 70, the system control circuit 50 detects it and controls the power control circuit 80 to power off the digital camera 100.

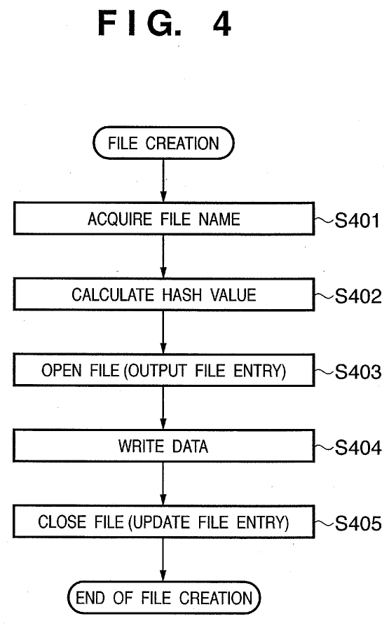

When the operator presses the shutter switch SW1, the system control circuit 50 detects it and controls the distance measurement control circuit 42 to execute photometry/distance measurement processing. When the shutter switch SW2 is pressed, the system control circuit 50 detects it. The processing advances to step S804 through step S803 so that the units are controlled to sense an image (step S804). That is, in step S804, image data based on an image signal obtained by image sensing is obtained and stored in the memory 30. On the basis of the image data stored in the memory 30, an image file is created and saved in the external recording medium 200 (step S805). The processing of creating an image file and saving it in the external recording medium 200 will be described later in detail with reference to FIG. 4.

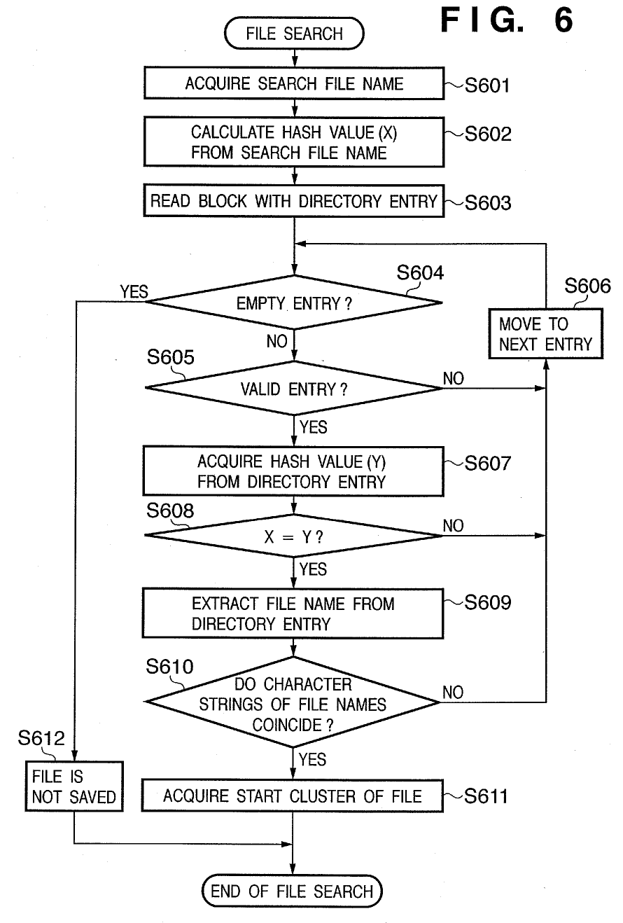

If a playback mode is set is step S801, the processing advances to step S806. To read out the image file from the image processing circuit 20 and play back, on the image display unit 54, an image based on the image data in the readout file, image files saved in the external recording medium 200 are searched for the desired image file (step S806). Normally, the image file most recently stored in the external recording medium 200 is searched for and played back. The processing in step S806 will be described later in detail with reference to FIG. 6.

When the image file as the search target is found, the processing advances to step S807 to output an image based on the image data in the found image file to the image display unit 54 and display the image there (step S807).

After the display processing in step S807, an operation input from the operator is waited for. When an instruction to power off the camera is input by, e.g., re-pressing the power button provided on the operation unit 70, the system control circuit 50 detects it and controls the power control circuit 80 to power off the digital camera 100.

If an instruction to advance the image is input by operating the operation unit 70, the processing returns to step S806 through step S808 to search for the next image file (normally, the image file immediately precedingly saved in the external recording medium 200 prior to the currently displayed image file).

If an instruction to delete an image is input by operating the operation unit 70, the processing advances to step S809 through step S808 to delete the designated image file (e.g., currently displayed image file) from the external recording medium 200 (step S809). In the file system, the delete processing is realized by writing a specific signature in the directory entry.

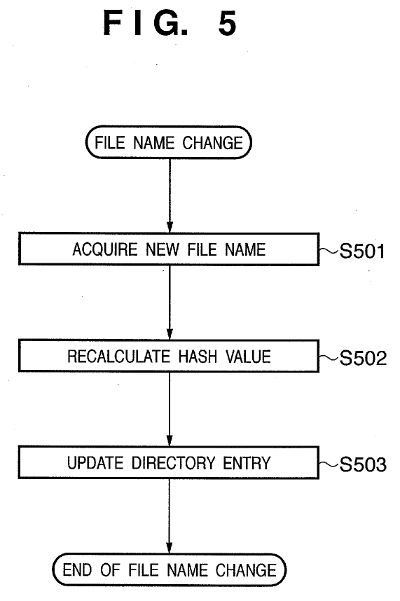

If an instruction to change (rename) the name of an image file is input by operating the operation unit 70, the processing advances to step S810 through step S808 to change the file name of the designated image file (e.g., currently displayed image file) (step S810). The processing in step S810 will be described later in detail with reference to FIG. 5.

<Creation and Save Processing of Image File>

FIG. 4 is a flowchart showing details of image file creation and image file save processing in step S805.

The file name of an image file to be created is acquired (step S401). The file name is based on the DCF (Design rule for Camera File System) standard. A number which is incremented every time an image file is created defines a file name. In step S401, the file name of the image file to be created is acquired by acquiring the number. However, the file name acquisition method is not limited to this. For example, when the operator sets a desired name by operating the operation unit 70, an input character string is acquired as a file name.

A hash value is calculated on the basis of the acquired file name (character string) (step S402). In this embodiment, a hash value is calculated on the basis of the acquired file name. If the image file saving destination is determined in advance, a hash value may be calculated on the basis of a full path name (character string) representing the saving location of the image file.

In this embodiment, both uppercase and lowercase characters can be used in the character string of a file name or full path name. When a hash value is to be calculated on the basis of a file name or full path name, the character codes of characters unified in uppercase or lowercase (the uppercase or lowercase is determined in advance depending on the system of the digital camera 100) are obtained.

A hash value is calculated by using the obtained character codes. For example, a hash value calculated on the basis of a file name “tTt” and a hash value calculated on the basis of a file name “tTT” are different. Hence, these hash values are handled as different in search to be described later even when the letters of the alphabet used in the character strings are the same.

The above-described processing does not change the character string of the file name (full path name).

The character string of the file name (full path name) is not changed. For this reason, even when the image file use din the digital camera 100 is transferred to another apparatus (e.g., a PC (Personal Computer) or another digital camera), and the same search processing as in the digital camera 100 is done at the transfer destination, the same result is obtained. If the file name (full path name) is changed, no same result is obtained when the image file is transferred to another apparatus, and the same search processing as in the digital camera 100 is done at the transfer destination.

Next, the file name, file attribute, creation date/time, and hash value are written in the directory entry (step S403). The hash value write timing is not particularly limited. The hash value may be written not in file open but in file close. Next, image data is written (step S404).

File close processing is executed (step S405). In the close processing, information such as access date/time, file size, and start cluster is written, thereby ending file creation. A directory entry containing the hash value based on the file name (full path name) is created on the external recording medium 200.

<Image File Name Change Processing>

FIG. 5 is a flowchart of image file name change processing in step S810.

A newly input file name (character string) is acquired (step S501). A hash value is calculated on the basis of the acquired file name, as in the processing in step S402 (step S502). The file name and hash value of the directory entry of the image file as the file name change target are updated to the file name acquired in step S501 and the hash value calculated in step S502, thereby updating the directory entry (step S503).

<Image File Delete Processing>

In the image file delete processing in step S809, it is only necessary to write a signature representing delete in the directory entry, like FAT, although the processing is not illustrated (in FAT, the start of the directory entry is changed to “E5H”). As described above, a general file operation such as file creation processing, file name change processing, or file delete processing can be implemented by only changing part of a directory entry as before, and load is rarely applied to the file system.

According to the method proposed in Japanese Patent Laid-Open No. 2000-10843, hash table list replacement is necessary even in these operations. Information of remaining unrelated directory entries must also be changed every time. Hence, the processing is obviously cumbersome as compared to this embodiment.

<Image File Search Processing>

FIG. 6 is a flowchart of image file search processing in step S806. In this search processing, image files saved in the external recording medium 200 are searched for an image file having a desired file name. In the digital camera 100, when an image file saved in the external recording medium 200 is to be played back on the image display unit 28, or image data is to be output to an external printer through the connector 112, quick search of a desired file is necessary. To implement this, the following search processing is executed in this embodiment.

The operator inputs the file name of an image file as a search target by using the operation unit 70. The system control circuit 50 acquires the input file name (character string) (step S601). The file name can be acquired by any other method. For example, the system control circuit 50 always holds the file name of an image file most recently saved in the external recording medium 200 and acquires this file name in step S601.

A hash value (X) is calculated on the basis of the acquired file name (step S602). As described above, the hash value of each image file, which is included in the directory entry, is calculated by using a character string unified in the uppercase or lowercase. Hence, in step S602, a character string is obtained by unifying the character string acquired in step S601 in the uppercase or lowercase, and a hash value is calculated by using the obtained character string. If the character string is not unified in the uppercase or lowercase, an image file with a file name “tTt” cannot be hit by inputting “TTT” because they have different hash values.

A physical block (sector) containing the directory entry is read out from the external recording medium 200 to the memory 30 (step S603).

If it is determined by referring to the signature of the read directory entry that the block has no entry (in FAT, when a directory entry starts with “00H”, no further directory entry is present), the processing advances to step S612 through step S604. A message indicating that no image file having a file coinciding with the file name received in step S601 is saved in the external recording medium 200 is output as a notification (step S612). The form of notification is not particularly limited. A message text may be displayed on the image display unit 28, or message voice may be output.

If it is determined by referring to the signature of the read directory entry that the block has an entry, the processing advances from step S604 to step S605 to confirm whether the directory entry is valid (step S605). In FAT, when a directory entry starts with “E5H”, the directory entry is already deleted. In addition, “01H, 02H, . . . ” indicate entries with long file names so these entries are no search target.

If the directory entry is not valid, the processing advances to step S606 to move the reference target to the next directory entry because the current directory entry is no search target (step S606). The processing returns to step S604 to execute the processing for the next directory entry.

If the directory entry is valid, the processing advances to step S607 to acquire a hash value (Y) from the directory entry (step S607).

The “hash value (X) calculated on the basis of the file name of the image file as the search target” in step S602 is compared with the hash value (Y) calculated in step S607 to check whether they are identical (step S608).

If X≠Y, the processing returns to step S606. If X=Y, the processing advances to step S609 to extract the file name (short file name or long file name) used to calculate the hash value (Y) from the directory entry (step S609).

The character string of the extracted file name is compared with that of the file name acquired in step S601 to check whether they are identical (step S610). Even in this check, the character strings of the file names are unified in the uppercase or lowercase and compared.

If NO in step S610, the processing returns to step S606. If YES in step S610, the processing advances to step S611 to acquire the start cluster of the image file having the file name used to calculated the hash value (Y) (step S611).

With the above processing, the image file as the search target can be found.

As described above, according to this embodiment, a directory entry contains a hash value calculated on the basis of a file name (or the full path name of a file) in creating the image file. In searching for an image file, a hash value is obtained for the image file as the search target. Only when the hash value coincides with the hash value in the directory entry, the file name is extracted, and the character strings of the file names are compared. In the file system to implement this, general file processing can be executed by simple processing such as addition or update to the directory entry, and no cumbersome processing is necessary.

In file search, only when hash values coincide with each other, the file name is extracted from the directory entry. Hence, no unnecessary load is applied to search processing even when directory entries having a long file name and complex data structure are long and enormous in quantity.

In case of a short file name, search can be done only by comparing hash values without executing character string comparison. Hence, quick and efficient search can always be executed.

When the character string of a file name has both uppercase characters and lowercase characters, conversion processing of temporarily unifying the file name in the uppercase or lowercase is performed to normally execute hash value calculation or character string comparison without any error. Hence, the cumbersome processing by the character case difference can be simplified, and the efficiency can be increased.

### Second Embodiment

In the first embodiment, in calculating a hash value on the basis of a file name, the characters of the file name are unified in the uppercase or lowercase to obtain a character string, and a hash value is calculated by using the character codes of the obtained character string. This is because both the uppercase and lowercase can be used in the file system of the first embodiment.

However, some file systems can use only uppercase or lowercase characters. In this case, in calculating a hash value on the basis of a file name, processing of obtaining a character string unified in the uppercase or lowercase is unnecessary. A hash value can be calculated by directly using the character codes of the character string of the file name.

The image file creation processing, save processing, and processing of searching for a desired image file from saved image files, which are described in the first embodiment, need not always be executed in the image sensing apparatus. The processing may be executed in a general PC (Personal Computer), WS (WorkStation), camera phone, or PDA.

An image file as a search target need not always be held in the apparatus which executes search processing. A desired image file may be calculated from image files saved in another apparatus.

### Third Embodiment

In the first and second embodiments, a hash value is calculated on the basis of only a file name. In the third embodiment, a hash value is obtained by adding information about a file to a value calculated on the basis of a file name.

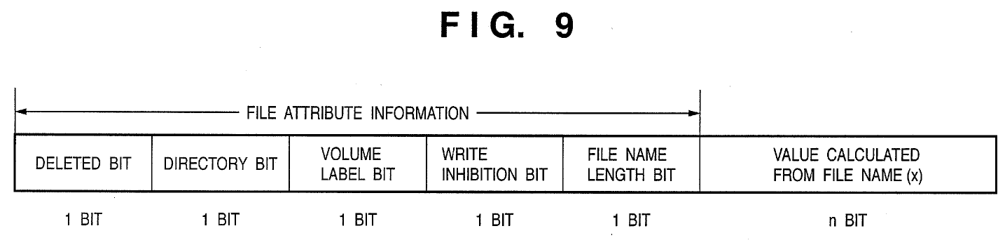

FIG. 9 shows an example.

Referring to FIG. 9, a value calculated on the basis of the file name of an image file, as in the first or second embodiment, is defined as x containing n bits.

If the image file has a long file name, a hash value X which should be obtained in this embodiment is given by
X=x+(1<<n)

. . . (file name length bit is 1)

If the image file is write-inhibited, the hash value X to be obtained is given by
X=x+(1<<n+1)

. . . (write inhibition bit is 1)

The hash value is recorded in a directory entry together. When a volume label whose entry is present in the directory is used, the hash value X to be obtained is given by
X=x+(1<<n+2)

. . . (volume label bit is 1)

When the directory entry is used, the hash value X to be obtained is given by
X=x+(1<<n+3)

. . . (directory bit is 1)

If the image file has been deleted, the hash value X to be obtained is given by
X=x+(1<<n+4)

. . . (deleted bit is 1)

In this way, the attribute information bit of the file is assigned to the conventional hash value. The attribute of the file can be acquired only by checking a specific bit of the hash value without checking the directory entry.

When such a hash value is used, not only single file search by conventional file name search but also file attribute search can be executed so that a plurality of files with a specific file attribute can be found.

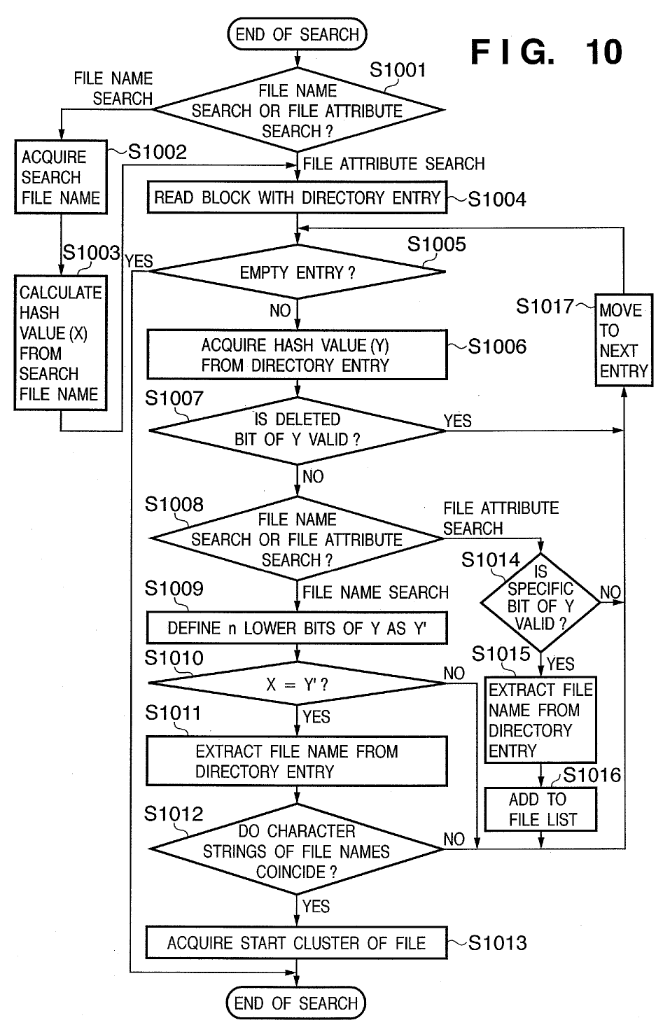

File search processing of this embodiment will be described below with reference to a flowchart of this processing shown in FIG. 10.

In step S1001, file name search or file attribute search is selected. In file name search, a hash value (X) is calculated on the basis of a file name as a search target in steps S1002 and S1003.

In step S1004, a block with a directory entry is read. In step S1005, if the entry is not empty, a hash value (Y) is acquired from the directory entry in step S1006.

If the deleted bit of the hash value Y is valid in step S1007, the flow advances to step S1017 to move to the next entry.

If the deleted bit of the hash value Y is invalid, file name search or file attribute search is determined in step S1008. In file name search, the flow advances to step S1009.

In step S1009, an n-bit value Y′ (a value calculated from the file name) is acquired by removing the file attribute bit from Y.

In step S1010, the hash value X of the file as the search target is compared with Y′. If the values coincide, the character strings of the files are compared. This processing is repeatedly executed until a single coinciding file is found.

In file attribute search in step S1008, the file attribute information bit of Y is checked ins step S1014 to check whether the desired file attribute bit is valid.

If YES in step S1014, a list of valid files is added in step S1015 and 51016.

When this processing is continued until the entry becomes empty, files having a specific file attribute can be acquired.

When a file attribute bit is added to a hash value, not only a single file based on a file name but also files having a specific file attribute such as write-inhibited files, files with long file names, or directories can easily be acquired from the directory entry list.

### Other Embodiment

The object of the present invention is achieved even by supplying a recording medium (storage medium) which records software program codes to implement the functions of the above-described embodiments to a system or apparatus and causing the computer (or CPU or MPU) of the system or apparatus to read out and execute the program codes stored in the storage medium. In this case, the program codes read out from the recording medium implement the functions of the above-described embodiments by themselves, and the storage medium which stores the program codes constitutes the present invention.

The functions of the above-described embodiments are implemented not only when the readout program codes are executed by the computer but also when the operating system (OS) running on the computer performs part or all of actual processing on the basis of the instructions of the program codes.

The functions of the above-described embodiments are also implemented when the program codes read out from the storage medium are written in the memory of a function expansion board inserted into the computer or a function expansion unit connected to the computer, and the CPU of the function expansion board or function expansion unit performs part or all of actual processing on the basis of the instructions of the program codes.

When the present invention is applied to the recording medium, program codes corresponding to the above-described flowcharts are stored in the recording medium.

As many apparently widely different embodiments of the present invention can be made without departing from the spirit and scope thereof, it is to be understood that the invention is not limited to the specific embodiments thereof except as defined in the appended claims.

This application claims the benefit of Japanese Applications No. 2005-023941, filed Jan. 31, 2005 and Japanese Patent Application No. 2005-280371, filed Sep. 27, 2005, which are hereby incorporated by reference herein in their entirety.

What is claimed is:

1. An image processing apparatus for storing an image in a recording medium, comprising:
acquisition means for acquiring identification information to identity an image file in storing the image file in the recording medium;
calculation means for calculating a hash value on the basis of the identification information; and
storage control means for controlling to store the image file in the recording medium in association with the hash value.

2. The apparatus according to claim 1, wherein said acquisition means acquires, as the identification information of the image file, one of a file name of the image file and a full path name representing a recording location of the image file in the recording medium.

3. The apparatus according to claim 1, wherein said calculation means calculates the hash value on the basis of character codes of a character string in which characters of the identification information are unified in one of an uppercase and a lowercase.

4. The apparatus according to claim 1, wherein said storage control means controls to store the hash value in a directory entry corresponding to the image file.

5. The apparatus according to claim 1, further comprising:
input means for inputting a file name of an image file as a search target;
second calculation means for calculating a hash value on the basis of the file name input by said input means;
search means for searching for a file name of an image file stored in the recording medium in association with a hash value which coincides with the hash value calculated by said second calculation means; and
reading means for reading out the image file with the file name found by said search means when a character string of the file name found by said search means coincides with the character string input by said input means.

6. The apparatus according to claim 5, wherein said second calculation means calculates the hash value on the basis of character codes of a character string in which characters of the identification information are unified in one of an uppercase and a lowercase.

7. An image processing method of storing an image in a recording medium, comprising:
an acquisition step of acquiring identification information to identity an image file in storing the image file in the recording medium;
a calculation step of calculating a hash value on the basis of the identification information; and
a storage control step of controlling to store the image file in the recording medium in association with the hash value.

8. A program causing a computer to execute an image processing method of claim 7.

9. A computer-readable storage medium storing a program of claim 8.

10. An image processing method of storing an image in a recording medium, comprising:
an identification information acquisition step of acquiring identification information to identity an image file in storing the image file in the recording medium;
a file information acquisition step of acquiring file information of the image file;
a calculation step of calculating a hash value on the basis of the identification information and the file information; and
a storage control step of controlling to store the image file in the recording medium in association with the hash value.

11. The method according to claim 10, wherein the file information is related to an attribute of a file, which represents whether the file has a long file name, whether the file is a deleted file, whether a volume label name is present, whether the file has a write inhibition attribute, or whether a directory name is present.

12. An image processing apparatus for storing an image in a recording medium, comprising:
identification information acquisition means for acquiring identification information to identity an image file in storing the image file in the recording medium;
file information acquisition means for acquiring file information of the image file;
calculation means for calculating a hash value on the basis of the identification information and the file information; and
storage control means for controlling to store the image file in the recording medium in association with the hash value.

13. A program causing a computer to execute an image processing method of claim 10.

14. A computer-readable storage medium storing a program of claim 13.
